(19) United States
(12) Patent Application Publication
(10) Pub. No.: US 2026/0243312 A1
(43) Pub. Date: Aug. 20, 2026

(54) OVERLOAD CLUTCH WITH A ROTATION AXIS

(71) Applicant: Schaeffler Technologies AG & Co. KG, Herzogenaurach (DE)

(72) Inventors: Viktor Lichtenwald, Fürth (DE); Knut Erdmann, Nürnberg (DE)

(73) Assignee: Schaeffler Technologies AG & Co. KG, Herzogenaurach (DE)

(21) Appl. No.: 19/164,619

(22) PCT Filed: Feb. 16, 2024
(86) PCT No.: PCT/DE2024/100128

§ 371 Date: Sep. 12, 2025

(30) Foreign Application Priority Data
Mar. 15, 2023 (DE) 10 2023 106 523.8
May 16, 2023 (DE) 10 2023 112 812.4

(51) Int. Cl. F16D 7/02; B60K 1/00; B60K 17/02; B60K 17/04; H02K 7/108; H02K 7/116

(52) U.S. Cl. CPC F16D 7/021; B60K 1/00; B60K 17/02; B60K 17/04; H02K 7/108; H02K 7/116

(57) ABSTRACT

An overload clutch includes a first shaft, a first friction element connected torque-transmittingly to the first shaft, a second shaft, arranged concentric to the first shaft, and a second friction element connected torque-transmittingly to the second shaft. The second friction element is statically frictionally connected to the first friction element such that the first shaft is connected torque-transmittingly to the second shaft below a predetermined slip torque. The first friction element and the second friction element are arranged radially between the first shaft and the second shaft. A shaft system including the overload clutch, an electric motor including the shaft system, and a drive train including the electric motor are also disclosed.

### CROSS-REFERENCE TO RELATED APPLICATIONS

This application is the United States National Phase of PCT Appln. No. PCT/DE2024/100128 filed Feb. 16, 2024, which claims priority to German Application Nos. DE 102023106523.8 filed Mar. 15, 2023 and DE 102023112812.4 filed May 16, 2023, the entire disclosures of which are incorporated by reference herein.

### TECHNICAL FIELD

The present disclosure relates to an overload clutch with a rotation axis, a shaft system having such an overload clutch with a rotation axis for a drive train, an electric motor having such a shaft system with a rotation axis for a drive train, a drive train having such an electric motor, and a motor vehicle having such a drive train.

The present disclosure relates to an overload clutch (also commonly referred to as a slip clutch) by means of which, below a predetermined torque (a predetermined slip torque), a torque is transmitted by (static) friction from an input part, in particular an outer shaft or an inner shaft, to an output part, in particular an inner shaft or an outer shaft, and by means of which the (static) frictional engagement is canceled at or above the predetermined slip torque or is reduced to a transmittable torque having the magnitude of the predetermined slip torque or less.

### BACKGROUND

In motor vehicles having combustion engines or hybrid drive trains, the starting clutch or the separating clutch is used as an overload clutch. A starting clutch is not provided for electric axle modules, referred to as electric axles. As a result, the parts of the electric axle are for possible overloads, for example an overload resulting from a torque peak when a driven wheel comes into contact with the road surface after the wheel has previously lost contact due to an uneven road surface. The overload clutch makes it possible to reduce the safety factors of the parts and thus potentially reduce costs and/or installation space.

Known overload clutches are usually designed with a large diameter, such as a conventional starting clutch. This means that such an overload clutch usually has to be inserted into a drive train using additional axial installation space. Especially in motor vehicles having electric axles, which have until now been designed without an overload clutch, such additional axial installation space is not available.

### SUMMARY

The present disclosure provides a slip clutch which can be used in particular under the spatial conditions of an electric axle, i.e., which requires little additional axial (and, for example, also no additional radial) installation space.

The present disclosure relates to an overload clutch with a rotation axis, having at least the following components:
a first shaft;
a second shaft;
a first friction element connected torque-transmittingly to the first shaft; and
a second friction element connected torque-transmittingly to the second shaft.

The first friction element is in static frictional contact with the second friction element up to a predetermined slip torque.

The two shafts are connected torque-transmittingly to one another exclusively by means of the friction elements in a limited manner predetermined according to the slip torque.

The first shaft and the second shaft are arranged concentrically in relation to each other and the friction elements are arranged radially between these shafts.

Reference is made below to the stated rotation axis when the axial direction, radial direction or the circumferential direction and corresponding terms are used, unless explicitly stated otherwise. Unless explicitly stated otherwise, ordinal numbers used in the preceding and subsequent description are used only for the purposes of clear distinction and do not indicate an order or a ranking of designated components. An ordinal number greater than one does not necessarily mean that a further such component must be present.

The overload clutch (or slip clutch), for example, is designed for a conventional task, namely to prevent the transmitting of a torque peak above a designed maximum transmittable torque (about the rotation axis). For this purpose, torque transmission is either (almost) completely interrupted or it is limited to the slip torque or the designed maximum transmittable torque when a predetermined slip torque corresponding to the maximum transmittable torque as per design is reached or exceeded. It should be noted that a deviation of up to +/−15% [plus or minus fifteen percent] around a designed slip torque may occur due to material pairing variations and/or over the service life; for example, the slip torque may be set 15% lower than a designed maximum transmittable torque.

During normal operation, the first shaft and the second shaft are connected to each other torque-resistantly (e.g., almost) without loss as far as possible. However, the torque-resistant connection can be interrupted by means of the friction elements as stated above at a predetermined slip torque. During normal operation, i.e., below the predetermined slip torque, the friction elements are connected to one another torque-resistantly with a predetermined static friction force or a predetermined static friction torque. When the predetermined slip torque is reached or exceeded, the static friction is exceeded and slipping occurs, and the two shafts are rotated relative to each other.

Here it is proposed that the first shaft and the second shaft are arranged concentrically in relation to each other. One (for example the first) shaft is an outer shaft designed as a hollow shaft and the other (then, for example, the second, alternatively the first) shaft is designed as an inner shaft extending at least partially in the outer shaft. This results in an axial overlap portion of the two shafts. The friction elements are arranged radially between the two shafts in the axial overlap portion. The first friction element (at least in the normal state) is directly connected (i.e., assigned to it) to the first shaft in a torque-transmitting manner and the second friction element (at least in the normal state) is directly connected (i.e., assigned to it) to the second shaft in a torque-transmitting manner. Furthermore, the friction elements (in the normal state) are in direct torque-transmitting contact with each other.

In a simple embodiment, at least one of the friction elements is connected torque-resistantly (or for conjoint rotation) to the assigned shaft, for example formed in one piece, for example formed (for example turned) from a common base material. Alternatively, both friction elements are torque-transmittingly connected so as to be displaceable axially relative to their respective assigned shafts.

In one embodiment, the desired (i.e., predetermined) slip torque is automatically set during assembly by correctly carrying out the assembly, for example by tightening a screw with a predetermined torque. Alternatively or additionally, the predetermined slip torque is set in a subsequent test, e.g., by slipping several times, in order to allow the friction elements and the possibly relatively rotatable shaft(s) of the two shafts to run in. This ensures that slippage occurs in the designed situation during operation.

It should be noted that the friction torque required for the predetermined slip torque is generated by means of a normal force required to generate the necessary friction force [the friction force is equal to the product of the normal force and the (static) friction coefficient of the friction pairing, i.e., the material pairing and, if applicable, lubrication] with axial orientation, radial orientation or orientation inclined with respect to the rotation axis. Furthermore, it should be noted that the normal force itself results from a preload force which is oriented radially, axially or inclined with respect to the rotation axis. At least one of the friction elements is expandable or compressible and/or (in a simple embodiment exclusively) displaceable in the direction of the required normal force.

In one embodiment, at least one of the friction elements is a sintered friction material, a metallic and/or an organic friction material.

In one embodiment, at least one of the friction materials for at least one of the friction elements is formed by a coating on a core material or carrier material and/or in a multilayer construction.

It is further proposed in an example embodiment of the overload clutch that the friction elements each include at least one wedge ring, with the wedge rings being axially clamped against one another according to the predetermined slip torque in such a way that a corresponding friction force acting in a circumferential direction is generated for the torque transmission between the concentric shafts.

At least one of the wedge rings may have a slot interrupting the complete circumference.

In this case, it is proposed that the friction elements are designed as wedge rings so that an axial preload force is diverted into a radial normal force or a normal force inclined with respect to the rotation axis, from which the circumferentially directed friction force arises to generate the desired friction torque (or predetermined slip torque). In this case, a first friction element overlaps axially with at least one, e.g., two, second friction elements, and/or a second friction element overlaps axially with one, e.g., two, first friction elements.

In the overlap portion of the two shafts, at least one first such annular friction element with a wedge-like inner profile, i.e., conical over the entire or partial periphery, is provided as a contact profile on the inner periphery of the outer shaft (for example, the first shaft). In the overlap portion of the two shafts, at least one second such annular friction element with a conical outer profile corresponding to the conical inner profile of the outer shaft is provided as a contact profile on the outer periphery of the inner shaft (then corresponding to the second shaft). The two friction elements are preloaded against each other by means of a preloading device acting in an axial direction of the two shafts. As a result, the conical inner profile is in (static) frictional contact with the corresponding conical outer profile and thus a torque can be transmitted between the outer shaft and the inner shaft up to the predetermined slip torque.

In an example embodiment, at least one of the friction elements includes a plurality of (axially stacked) wedge rings or a plurality of such friction elements is provided which may each be formed by a wedge ring. In one embodiment, a plurality of first friction elements and/or a plurality of second friction elements are arranged axially in succession in the outer shaft and/or on the inner shaft. In this embodiment, at least with the exception of a single wedge ring, e.g., all of the wedge rings (which are present in a plurality) are axially displaceable towards one another relative to the assigned shaft, such that the wedge rings can be pressed against one another as a result of an axial preload force. For example, two or more wedge rings are provided on each assigned shaft, in a corresponding number, for example one wedge ring more on one shaft than on the other shaft. For example, the axially inner wedge rings (in the respective configurations) each have a wedge surface inclined upwards (i.e., rising) in an axial direction and a wedge surface inclined downwards (i.e., falling), such that these wedge rings have a roof-like (contact) profile. Thus, in a sectional view, the inner profiles and outer profiles of the axially stacked wedge rings result in a contact surface with a zigzag course (interrupted in the edge regions of the course).

In an example embodiment, a slot is provided in at least one of the friction elements designed as a wedge ring, so that the wedge ring in question is considerably softer for radial expansion or compression than a closed ring made of the same material and the same profile cross-section. In one embodiment, the slot is formed to be axially continuous. In an alternative embodiment, the slot is not axially continuous, i.e., is designed as a blind recess. In an alternative embodiment, the slot is designed to be axially closed on both sides (i.e., as an opening with a radial axis and/or an axis oriented along a secant). In one embodiment, a plurality of such non-continuous or closed (e.g., similar) slots and, optionally additionally, a continuous slot are provided. Alternatively, the material of the wedge ring is soft enough for the desired expansion or compression to generate the predetermined slip torque.

It is further proposed in an example embodiment of the overload clutch that a spring assembly for preloading the friction elements is provided radially inside the outer shaft of the two shafts.

The spring assembly may have a plurality of disc springs.

By means of the spring assembly (a preloading device for generating the required axial preload force, radial preload force or preload force inclined with respect to the rotation axis), adjustability is achieved as a result of the extension of the preload distance due to the reduced spring stiffness. This simplifies assembly and/or allows for a larger tolerance range to be compensated for. In one embodiment, the preloading device is designed as a disc spring, e.g., as a stack of disc springs (oriented identically and/or mirrored with respect to each other).

It is further proposed in an example embodiment of the overload clutch that the first wedge ring is clamped in a predetermined manner exclusively by static friction so as to transmit torque.

The second wedge ring is connected axially movably and torque-resistantly to the second shaft by means of a tooth system.

The embodiment proposed here for a radially expanding or compressed wedge ring includes said wedge ring connected to the assigned shaft by means of static friction without play, regardless of a tolerance-related or different required predetermined slip torque. Alternatively, a tooth system with corresponding play would have to be provided or a more complicated solution, such as wedging circumferentially, would have to be used.

The other wedge ring may be designed without or with negligible expansion or compression, and may be connected torque-resistantly to the assigned shaft by means of a corresponding tooth system, e.g. a spline with a small amount of play or a slightly underdimensioned portion (i.e., press fit). The wedge ring may be designed to be axially displaceable for assembly and, if necessary, for the case of overload.

It is further proposed in an example embodiment of the overload clutch that the first shaft has a threaded receptacle for a preloading screw.

The preloading screw may have, outside the threaded receptacle, at the same time, a threaded portion for a counter element, e.g., for a clamping nut for a bearing ring.

Here it is proposed that the first shaft (e.g., as an external shaft) has a threaded receptacle, i.e., in one embodiment as an outer shaft it has a female thread. The corresponding preloading screw can be screwed into or onto the threaded receptacle using its corresponding counter thread. This thread pairing may be self-locking. Alternatively or additionally, a securing element, for example a retaining ring and/or a counter element, is provided. The counter element has, for example, a female thread, which may be screwed (in an extended axial portion) onto the aforementioned counter thread of the preloading screw (e.g., for securing). Alternatively, an additional thread and/or a further step on the preloading screw is provided for the counter element. Alternatively, a different fastening concept for the counter element is also provided, for example pressing on, welding and/or adhesive bonding.

In an example embodiment, the counter element is also designed as a clamping nut for a bearing ring of a (for example, rolling) bearing for the first shaft.

It is further proposed in an example embodiment of the overload clutch that an axially acting counter sleeve for receiving the axial preload of the friction elements is fixed in the first shaft.

In this embodiment, a force clamp is simply formed in a single one of the shafts so that it is not necessary to provide a counter bearing for the preload force of the friction elements. Easy assembly and/or adjustment for the friction elements and/or the second shaft can be achieved by means of the counter sleeve (as an alternative to a corresponding shoulder on the first shaft to form the force clamp). Alternatively or additionally, for a relative support of the two shafts against each other, a suitable sliding pairing between the counter sleeve and the second shaft can be achieved easily or more cost-effectively, for example by means of the material selection for the counter sleeve and/or by means of a tolerance specification for certain regions, than if the second shaft is in direct contact with the first shaft (at all or over a large area).

According to a further aspect, a shaft system with a rotation axis for a drive train is proposed, having at least the following components:
a torque input;
a torque output; and
an overload clutch according to an embodiment as described above.

The torque input is connected torque-transmittingly to the torque output exclusively by means of the overload clutch.

In this case, a shaft system is proposed in which, in the normal state, the torque input and the torque output are connected torque-resistantly to one another (almost) as by means of a one-piece shaft. Only outside the normal state, i.e., in the case of overload, is torque transmission between the torque input and the torque output interrupted or limited to the maximum torque that can be transmitted as per design (corresponding to the predetermined slip torque) or a lower torque. For this purpose, the overload clutch is used according to an embodiment as described above. For example, the torque input is connected torque-resistantly to the first shaft and the torque output to the second shaft (or vice versa), for example formed as a surface for a press fit or teeth for a spline in one piece with the shaft. Alternatively, the torque input and/or the torque output is formed by a structurally separate unit and is connected to the shaft in a torque-resistant or interruptible and/or torque-transmitting manner.

It should be noted that the terms input and output do not exclude the possibility of a torque being transmitted in the opposite direction, i.e., from the torque output to the torque input. The designations torque input and torque output may be synonymous with the direction of a traction torque, for example in the drive train of a motor vehicle, i.e., an output of torque from a drive machine to a consumer (for example the drive wheels).

According to a further aspect, an electric motor with a rotation axis is proposed for a drive train, having at least the following components:
a stator;
a rotor; and
an overload clutch according to an embodiment as described above and/or a shaft system according to an embodiment as described above.

The rotor is connected torque-resistantly to one of the shafts, e.g., the radially outer shaft, of the overload clutch or to the torque input of the shaft system.

The electric motor proposed here (also referred to as electric machine or electric drive machine) includes the function of torque generation and/or recuperation of an externally applied torque and overload protection by means of at least one overload clutch. This means that the electric motor and/or elements torque-transmittingly connected to the electric motor are reliably protected from a torque peak that exceeds the maximum torque that can be transmitted as per design. No additional installation space is required, or only a negligible amount, or that already present in an installation situation, and so this electric motor can be used neutrally in terms of installation space (at least approximately) compared to an electric motor without an overload clutch. In one embodiment, a different maximum transmittable torque is set by means of a plurality of (e.g., two) overload clutches, for example a higher slip torque for a traction torque than for an overrun torque.

According to a further aspect, a drive train is proposed, having at least the following components:
at least one drive machine having an output shaft for outputting a torque;
at least one consumer for receiving a torque; and
a transmission gearing for transmitting a torque between the drive machine and the at least one consumer.

The drive train includes a shaft system according to an embodiment as described above and/or at least one of the drive machines is an electric motor according to an embodiment as described above.

A transmission of an overload torque beyond the predetermined slip torque between the output shaft and the at least one consumer is prevented by means of the overload clutch.

The drive train proposed here includes at least one drive machine, of which one may be an electric motor according to an embodiment as described above, and/or a (possibly further) drive machine, for example an internal combustion engine, a starter generator and/or a (further) electric drive machine. At least one of them forms the torque source of a torque flow in a main state. Furthermore, at least one consumer is included, for example drive wheels of a motor vehicle, which forms the torque sink of the torque flow at least in a main state. A transmission gearing is connected in between, via which the (e.g., entire wheel-side) torque flow is directed. In one embodiment, the torque transmission is protected from the transmission of a torque peak by means of a shaft system, e.g., integrated in the transmission gearing, and/or by means of an electric motor, each having an overload clutch.

The drive train proposed here includes an overload clutch which reliably limits the transmittable torque to a slip torque or interrupts transmission when the slip torque is reached. At the same time, the overload clutch can be used neutrally in terms of installation space, and conventional or conventionally designed components can continue to be used unchanged. Compared to a drive train without an overload clutch, components in the torque flow can be designed more slenderly and/or more cost-effectively.

According to a further aspect, a motor vehicle is proposed, having:
at least one drive wheel and a drive train according to an embodiment as described above.

For propulsion of the motor vehicle, a torque can be output from the at least one drive machine of the drive train to the at least one drive wheel.

A transmitting of an overload torque beyond the predetermined slip torque between the output shaft and the at least one drive wheel is prevented by means of the overload clutch.

The motor vehicle is, for example, a passenger car, a truck or a motorized two-wheeler. The motor vehicle has a drive train according to an embodiment as described above. The torque that can be output by the at least one drive machine is output to the at least one drive wheel (consumer) via the transmission gearing. The transmission gearing referred to here may be a shiftable transmission gearing. In one embodiment, the transmission gearing also includes, for example, a differential. In one embodiment, the torque transmission is protected from the transmission of a torque peak by means of a shaft system, e.g., integrated in the transmission gearing, and/or by means of an electric motor, each having an overload clutch.

The motor vehicle proposed here includes a drive train having an overload clutch which reliably limits the transmittable torque to a slip torque or interrupts transmission when the slip torque is reached. At the same time, the overload clutch can be used neutrally in terms of installation space, and conventional or conventionally designed components can continue to be used unchanged. Compared to a drive train without an overload clutch, components in the torque flow can be designed more slenderly and/or more cost-effectively.

Further example embodiments of an overload clutch (or slip clutch) are listed below:
1. A slip clutch having an outer shaft designed as a hollow shaft and an inner shaft extending concentrically at least partially in the outer shaft.
2. At least one first annular friction element having a conical inner profile is provided on an inner periphery of the outer shaft.
3. At least one second annular friction element having a conical outer profile is provided on an outer periphery of the inner shafts.
4. The two friction elements are preloaded against one another by means of a preloading device acting in an axial direction of the (mutually concentric outer and inner) shafts.
5. The conical inner profile is in frictional contact with the conical outer profile and a torque can be transmitted between the outer shaft and the inner shaft.

The slip clutch according to the above embodiment may also have the first friction element connected for conjoint rotation to the outer shaft, e.g., by means of a spline.

The second friction element may be connected for conjoint rotation to the inner shaft, e.g., by means of a spline.

The slip clutch according to one of the above embodiments may also have the conical inner profile and the conical outer profile, viewed axially, each designed to alternately rise and fall, such that a sectional view of the contact surface formed by the inner profiles and outer profiles has a substantially zigzag-shaped course.

The slip clutch according to one of the above embodiments may also have a plurality of first friction elements and/or a plurality of second friction elements arranged axially in succession in the outer shaft and/or on the inner shaft.

The slip clutch of one of the above embodiments may have a first friction element that overlaps axially with two second friction elements.

A second friction element may overlap axially with two first friction elements.

The slip clutch of one of the above embodiments may have the preloading device designed as a disc spring, e.g., as a stack of disc springs.

An example embodiment includes an electric machine, in particular an electric motor, having a rotor shaft which is designed as an outer shaft or inner shaft of the slip clutch according to one of the above embodiments

In an alternative embodiment, the rotor shaft may be connected for conjoint rotation to the outer shaft or inner shaft of the slip clutch according to one of the above embodiments.

An example embodiment includes an electric axle module or hybrid module for a motor vehicle having an electric machine according to one of the above embodiments.

### BRIEF DESCRIPTION OF THE DRAWINGS

The above disclosure is explained in detail below against the relevant technical background with reference to the associated drawings, which show example embodiments. The disclosure is in no way restricted by the purely schematic drawings; and it should be noted that the drawings are not dimensionally accurate and are not suitable for defining proportions. In the drawings:

FIG. 1 shows a detail of a drive train with an electric motor on an electric axle in a sectional view;

FIG. 2 shows a shaft system with an overload clutch in a partial quarter section;

FIG. 3 shows a drive train with a transmission gearing and consumer; and

FIG. 4 shows a plan view of a motor vehicle with a drive train.

### DETAILED DESCRIPTION

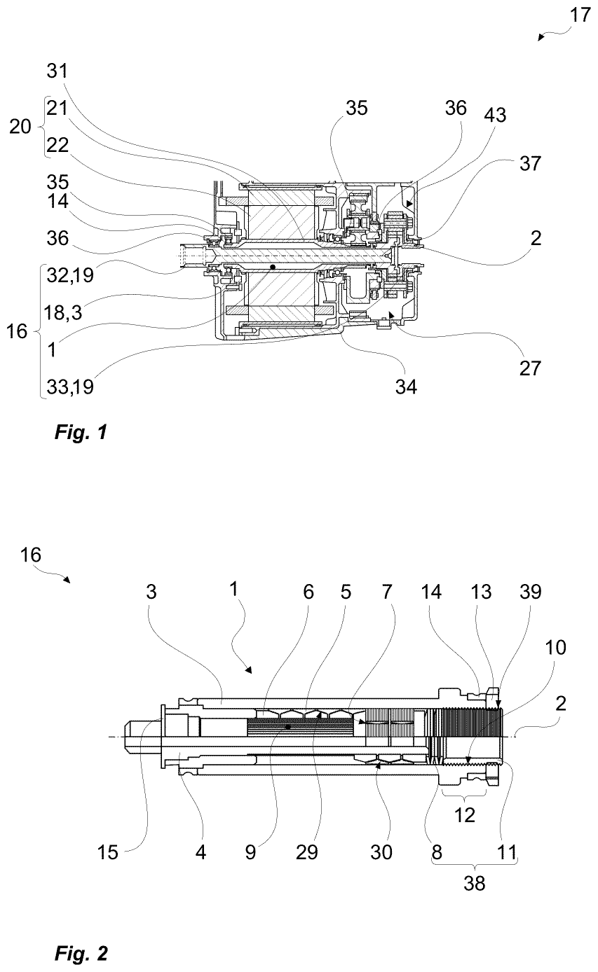

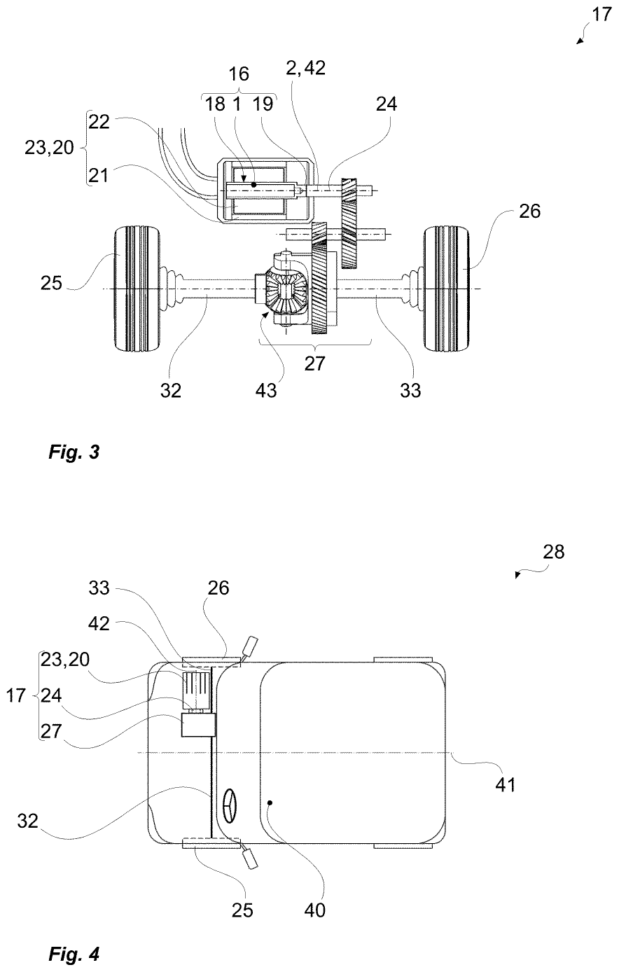

FIG. 1 shows a detail of a drive train 17 with an electric motor 20 on an electric axle for outputting a torque about a rotation axis 2 in a sectional view, which shows an electric motor 20, a transmission gearing 27 and a conventional rotor shaft 31 as an output shaft 24 (see FIG. 3). The electric motor 20 is designed in this case (purely optionally) with a conventional rotor shaft designed as a hollow shaft 31, which is connected torque-resistantly to a rotor 22 (for example a pressed-on laminated core). Thus, a torque input 18 (in a state of outputting a traction torque) is formed by means of the connection between the rotor 22 and the rotor shaft 31. The rotor 22 can be driven electromagnetically by means of a rotationally fixed stator 21. The rotor shaft 31 is mounted by means of a (first) bearing arrangement 35, of which the inner bearing ring 14 is shown on the left in the representation and is described in more detail in the following figure, FIG. 2.

The rotor shaft 31 is connected, on the right in the representation, torque-resistantly to a transmission gearing 27, in this case, for example, a planetary transmission (here purely optionally axially adjacent to the electric motor 20) and a (spur gear) differential 43 (as shown on the right). The left of the two drive shafts 32 shown here (torque output 19) is guided through the (hollow) rotor shaft 31 and mounted on the gearing housing 34 separately by means of a (second) bearing arrangement 36. The drive shaft 33, as shown on the right, mounted by means of a separate third bearing arrangement 37 (torque output 19) branches off to the right. In this case, (purely optionally), on the transmission gearing side, the bearings of the second bearing arrangement 36 and third bearing arrangement 37 are also configured, at the same time, to support the transmission 27.

The following figure, FIG. 2, shows a shaft system 16 which can be used as a replacement for the rotor shaft 31. It should be noted that the drive shafts 32, 33 are not replaced, but the corresponding left drive shaft 32 as a torque output 19 is guided through the (in principle, purely optionally) hollow second shaft 4 (see figure).

FIG. 2 shows a shaft system 16 having an overload clutch 1 in a partial quarter section with respect to its rotation axis 2. It shows a first shaft 3 (here the outer shaft) designed as a hollow shaft and a (likewise, purely optionally, hollow) second shaft 4 (here the inner shaft) extending concentrically at least partially in the first (outer) shaft 3. At least a first annular friction element 5 having a conical inner profile 29 is provided on an inner periphery of the first shaft 3. At least a second annular friction element 6 having a conical outer profile 30 is provided on an outer periphery of the second shaft 4. The two friction elements 5, 6 are preloaded against one another by means of a preloading device 38 acting in an axial direction of the two shafts 3, 4 so that the conical inner profile 29 is in (static) frictional contact (i.e., in surface contact) with the conical outer profile 30 and thus a torque can be transmitted between the first shaft 3 and the second shaft 4 in a manner limited to a maximum torque.

The preloading device 38, in this case, comprises a preloading screw 11 and a spring assembly 8, which comprises a plurality of (purely optionally arranged alternately in a mirrored manner) disc springs (here as a stack of disc springs). The preloading screw 11 is configured to adjust or preload the spring assembly 8 by interaction between a threaded receptacle 10, designed as a female thread, of the first shaft 3 and the counter thread 39 in the region of the threaded portion 12 of the preloading screw 11. It should be noted that other preloading devices 38 can be used, for example a coil spring and/or a hydraulic preloading device 38 and/or without a spring assembly 8.

In this embodiment, a counter element 13 is screwed with a corresponding female thread on the (here, purely optionally, continuous) counter thread 39 of the preloading screw 11, for example to produce or secure the self-locking of the preloading screw 11. In this case, an (inner) bearing ring 14, for example, of a (first) bearing arrangement 35 (see FIG. 1), is kept axially preloaded by means of the counter element 13. It should be noted that, if the corresponding bearing outer ring has a loose bearing seat or if the seat of the fixed bearing seat is axially adjustable, no double fit conflict occurs.

In the embodiment shown, the first friction element 5 is connected torque-transmittingly to the first shaft 3 (here the outer shaft) exclusively by means of static friction. In this case, a plurality of first friction elements 5 or first wedge rings 5 are arranged axially in succession (i.e., axially stacked) and radially inside the first shaft 3. The first wedge rings 5 are (purely optionally) designed with an axially continuous slot 7 and thus soft for radial expansion due to the axial preload by means of the preloading device 38.

In the embodiment shown, the second friction element 6 is connected torque-transmittingly to the second shaft 4 (here the inner shaft) by means of a (e.g., spline) tooth system 9. In this case, a plurality (here a second wedge ring 6 more), corresponding to the number of the first wedge rings 5, of second friction elements 6 or of second wedge rings 6 are arranged axially in succession (i.e., stacked axially) and radially outside the second shaft 4. The second wedge rings 6 are (purely optionally) designed to be circumferentially closed and thus rigid in terms of diameter with respect to radial compression as a result of the axial preload by means of the preloading device 38. Therefore, the (here inner) second wedge rings 6 are (almost) unchangingly, slightly axially displaceable on the (inner) second shaft 4.

The conical inner profile 29 and the conical outer profile 30 of the pair of the wedge rings 5, 6 are designed to alternately rise and fall, as viewed axially, so that the sectional view of the contact surface formed by the inner profiles 29 and the outer profiles 30 has a zigzag-shaped course. A first wedge ring 5 overlaps axially with two second wedge rings 6. Likewise, an (axially inner) second wedge ring overlaps 6 axially with two first wedge rings 5. The two axially outer second wedge rings 6 overlap (axially on the inside) with a single second wedge ring 6 and form, axially on the outside, in each case the axial contact for transmitting the axial preload force of the preloading device 38 (shown on the right) or the counter sleeve 15 (shown on left). The counter sleeve 15 is connected, for example pressed and/or welded, torque-resistantly to the first shaft 3. The second shaft 4 is supported in a manner (here slidingly) mounted in the counter sleeve 15 and rotatable relative to the first shaft 3 (and the counter sleeve 15) when the slip torque is reached.

Furthermore, (purely optionally and not shown here) intermediate rings are provided between each two adjacent wedge rings 5, 6 and, like the wedge rings 5, 6, are designed in one piece, in multiple pieces and/or elastically.

As already mentioned above, the outer shaft (here the first shaft 3) or the inner shaft (here the second shaft 4) of the overload clutch 1 is designed as the rotor shaft 31 of an electric motor20 and/or connected as a separate component in a torque-resistant manner to a rotor shaft 31 of an electric motor 20. The electric motor 20 is, for example, part of an electric axle module (also known as an electric axle) or a hybrid module of a drive train 17 of a motor vehicle 28 (see FIG. 4). In this case, the inner shaft (here the second shaft 4) is also designed as a hollow shaft, such that a drive shaft 32 (see FIG. 1) can be passed through.

FIG. 3 shows a drive train 17 having a shaft system 16 (see FIG. 2), an electric drive machine 23, a transmission gearing 27, a (bevel gear) differential 43 and a consumer. The output shaft 24 of the drive machine 23, i.e., of rotor shaft 31 in this case, is formed here by the shaft system 16 (compared to a rotor shaft 31 without an overload clutch 1, used neutrally in terms of installation space). The electric motor 20 and the shaft system 16 are shown in a sectional view. The drive machine 23 is connected torque-resistantly to its output shaft 24 by a transmission gearing 27 in a manner limited to a predetermined slip torque. The transmission gearing 27 includes, in addition to the transmission stage (for example, a, purely optionally, helical spur gearing), a differential 43 (here, purely optionally, a bevel gear differential). By means of the differential 43, the torque is split, as required, among the two drive shafts 32, 33 having the respective drive wheels 25, 26.

FIG. 4 shows a motor vehicle 28 with a drive train 17 schematically in a plan view, in which, in a transverse front arrangement, an electric motor 20 as a drive machine 23 with its output shaft 24 is arranged along the motor axis 42 and transverse to the longitudinal axis 41 and in front of the driver compartment 40 of the motor vehicle 28. The drive train 17 is configured to propel the motor vehicle 28 by driving a left drive wheel 25 and a right drive wheel 26 (here optionally of the front axle of the motor vehicle 28) by means of a torque output from the electric motor 20 via a transmission gearing 27. The torque transmission from the electric motor 20 can be passively interrupted by means of an overload clutch 1, which is designed, for example, as shown in FIG. 2 and integrated into the electric motor 20 and/or into the transmission gearing 27, and thus at least the electric motor 20 or, conversely, the rest of the drive train 17 is protected against overloads (e.g. torque shocks).

The overload clutch proposed here enables use radially inside an electric motor or a shaft system in a manner which is neutral in terms of installation space.

### REFERENCE NUMERALS

1 Overload clutch
2 Rotation axis
3 First shaft
4 Second shaft
5 First friction element
6 Second friction element
7 Slot
8 Spring assembly
9 Tooth system
10 Threaded receptacle
11 Preloading screw
12 Threaded portion
13 Counter element
14 Bearing ring
15 Counter sleeve
16 Shaft system
17 Drive train
18 Torque input
19 Torque output
20 Electric motor
21 Stator
22 Rotor
23 Drive machine
24 Output shaft
25 Left drive wheel
26 Right drive wheel
27 Transmission gearing
28 Motor vehicle
29 Inner profile
30 Outer profile
31 Conventional rotor shaft
32 Left drive shaft
33 Right drive shaft
34 Gearing housing
35 First bearing arrangement
36 Second bearing arrangement
37 Third bearing arrangement
38 Preloading device
39 Counter thread
40 Driver compartment
41 Longitudinal axis
42 Motor axis
43 Differential

1. An overload clutch having a rotation axis, comprising:
a first shaft;
a second shaft;
a first friction element connected torque-transmittingly to the first shaft; and
a second friction element connected torque-transmittingly to the second shaft, wherein:
the first friction element is in static frictional contact with the second friction element up to a predetermined slip torque,
the first shaft is connected torque-transmittingly to the second shaft exclusively by means of the friction elements in a limited manner predetermined according to the slip torque, and
the first shaft and the second shaft are arranged concentrically in relation to each other and the friction elements are arranged radially between these shafts.

2. The overload clutch according to claim 1, wherein:
the friction elements each comprise at least one wedge ring,
the wedge rings are axially clamped against one another according to the predetermined slip torque such that a corresponding friction force acting in a circumferential direction is generated for the torque transmission between the concentric shafts, and
at least one of the wedge rings has a slot interrupting the complete circumference.

3. The overload clutch according to claim 1, further comprising:
a spring assembly for preloading the friction elements arranged radially inside an outer one of the two shafts,
wherein the spring assembly preferably comprises a plurality of disc springs.

4. The overload clutch according to claim 1, wherein:
the first wedge ring is clamped in a predetermined manner exclusively by static friction so as to transmit torque, and
the second wedge ring is connected axially movably and torque-resistantly to the second shaft by means of a tooth system.

5. The overload clutch according to claim 1, wherein:
the first shaft has a threaded receptacle for a preloading screw,
the preloading screw, outside the threaded receptacle, at the same time has a threaded portion for a counter element arranged as a clamping nut for a bearing ring.

6. The overload clutch according to claim 1, wherein:
an axially acting counter sleeve for receiving the axial preload of the friction elements is fixed in the first shaft.

7. A shaft system having a rotation axis for a drive train, comprising:
a torque input;
a torque output; and
the overload clutch according to claim 1,
wherein the torque input is connected torque-transmittingly to the torque output exclusively by means of the overload clutch.

8. An electric motor having a rotation axis for a drive train, comprising:
a stator;
a rotor; and
the shaft system according to claim 7,
wherein the rotor is connected torque-resistantly to a radially outer one of the shafts of the overload clutch or to the torque input of the shaft system.

9. A drive train, comprising:
at least one drive machine having an output shaft for outputting a torque;
at least one consumer for receiving a torque; and
a transmission gearing for transmitting a torque between the drive machine and the at least one consumer,
wherein the drive train comprises the electric motor according to claim 8,
wherein a transmitting of an overload torque beyond the predetermined slip torque between the output shaft and the at least one consumer is prevented by means of the overload clutch.

10. A motor vehicle, comprising:
at least one drive wheel and a drive train according to claim 9,
wherein, for propulsion of the motor vehicle, a torque can be output from the at least one drive machine of the drive train to the at least one drive wheel and
a transmitting of an overload torque beyond the predetermined slip torque between the output shaft and the at least one drive wheel is prevented by means of the overload clutch.

11. An overload clutch, comprising:
a first shaft;
a first friction element connected torque-transmittingly to the first shaft;
a second shaft, arranged concentric to the first shaft; and
a second friction element connected torque-transmittingly to the second shaft and statically frictionally connected to the first friction element such that the first shaft is connected torque-transmittingly to the second shaft below a predetermined slip torque, wherein the first friction element and the second friction element are arranged radially between the first shaft and the second shaft.

12. The overload clutch of claim 11, wherein:
the first friction element comprises a first wedge ring; and
the second friction element comprises a second wedge ring, axially clamped against the first wedge ring.

13. The overload clutch of claim 12, wherein a one of the first wedge ring or the second wedge ring comprises a slot interrupting a circumference of the one of the first wedge ring or the second wedge ring.

14. The overload clutch of claim 11, further comprising a spring assembly for preloading the first friction element against the second friction element, the spring assembly arranged radially between the first shaft and the second shaft.

15. The overload clutch of claim 14, wherein the spring assembly comprises a plurality of disc springs.

16. The overload clutch of claim 11, wherein:
the first friction element is connected torque-transmittingly to the first shaft by static friction alone; and
the second friction element is connected axially movably and torque-transmittingly to the second shaft by a tooth system.

17. The overload clutch of claim 11, further comprising a preloading screw, wherein:
the first shaft comprises a threaded receptacle; and
the preloading screw is threaded into the threaded receptacle.

18. The overload clutch of claim 17, further comprising a counter element threaded onto the preloading screw outside of the threaded receptacle.

19. The overload clutch of claim 18, wherein the counter element is a clamping nut for a bearing ring.
